(19) United States
(12) Patent Application Publication
(10) Pub. No.: US 2024/0179097 A1
(43) Pub. Date: May 30, 2024

(54) IMAGE TRANSMISSION CONTROL DEVICE, METHOD, AND COMPUTER-READABLE RECORDING MEDIUM STORING PROGRAM

(71) Applicant: FUJITSU LIMITED, Kawasaki-shi (JP)

(72) Inventors: Tokuro KUBO, Kawasaki (JP); Akihiro WADA, Kawasaki (JP); Tatsuya KIKUZUKI, Kawasaki (JP); Kotaro SHIIZAKI, Kawasaki (JP); Kaoru YOKOO, Yokosuka (JP); Teruhisa NINOMIYA, Yokohama (JP)

(73) Assignee: FUJITSU LIMITED, Kawasaki-shi (JP)

(21) Appl. No.: 18/433,731

(22) Filed: Feb. 6, 2024

Related U.S. Application Data
(63) Continuation of application No. PCT/JP2021/035376, filed on Sep. 27, 2021.

(51) Int. Cl. H04L 47/25; H04L 41/147; H04L 47/70

(52) U.S. Cl. CPC H04L 47/25; H04L 41/147; H04L 47/823

(57) ABSTRACT

A device stores relationship information that indicates a correspondence relationship between a received signal strength indicator at a time of reception of a signal from a wireless transmission path and an available bandwidth of data transmission in the wireless transmission path; acquires a measurement value of the received signal strength indicator during communication with an image transmission device that transmits image data via a communication path; estimates a first available bandwidth in the wireless transmission path based on the measurement value and the relationship information; generates control information for adjustment of a transmission rate of image data in the image transmission device based on the first available bandwidth; transmits the control information to the image transmission device; measure a second available bandwidth in the wireless transmission path; and optimizes the correspondence relationship based on a comparison result between the first available bandwidth and the second available bandwidth.

### CROSS-REFERENCE TO RELATED APPLICATION

This application is a continuation application of International Application PCT/JP2021/035376 filed on Sep. 27, 2021 and designated the U.S., the entire contents of which are incorporated herein by reference.

### FIELD

The embodiments discussed herein are related to an image transmission control device, a method, and a program.

### BACKGROUND

In recent years, a speed of wireless communication has been increased. For example, as a wireless local area network (LAN), Wi-Fi 6 having a maximum communication speed of 9.6 Gbps has become widespread. Furthermore, as a mobile communication system, a 5th generation (5G) service having a maximum communication speed of equal to or greater than 2 Gbps been started.

Japanese Laid-open Patent Publication No. 2017-69849 and Japanese Laid-open Patent Publication No. 4-357787 are disclosed as related art.

### SUMMARY

According to an aspect of the embodiments, an image transmission control device includes: a memory; and a processor coupled to the memory and configured to: store, in the memory, relationship information that indicates a correspondence relationship between a received signal strength indicator at a time of reception of a signal from a wireless transmission path and an available bandwidth of data transmission in the wireless transmission path; acquire a measurement value of the received signal strength indicator during communication with an image transmission device that transmits image data via a communication path that includes the wireless transmission path; estimate a first available bandwidth in the wireless transmission path based on the measurement value and the relationship information; generate control information for adjustment of a transmission rate of image data in the image transmission device based on the first available bandwidth; transmit the control information to the image transmission device; measure, when image data that reflects the control information is received from the image transmission device, a second available bandwidth in the wireless transmission path based on the received image data; and optimize the correspondence relationship in the relationship information based on a comparison result between the first available bandwidth and the second available bandwidth.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example and a processing example of an image transmission system according to a first embodiment;

FIG. 2 is a diagram illustrating a configuration example of an image transmission system according to a second embodiment;

FIG. 3 is a diagram illustrating a hardware configuration example of a server;

FIG. 4 is a diagram illustrating a configuration example of processing functions provided in each device of the image transmission system;

FIG. 5 is a diagram for describing a conversion table;

FIG. 6 is a diagram illustrating an internal configuration example of an image quality control unit;

FIG. 7 is an example of a sequence diagram illustrating a flow of image transmission rate control processing;

FIG. 8 is an example of a time chart illustrating timings of acquisition of a received signal strength indicator (RSSI) value and measurement of an available bandwidth;

FIG. 9 is an example of a flowchart illustrating a processing procedure of an adaptive control unit;

FIG. 10 is a diagram illustrating an internal configuration example of the adaptive control unit;

FIG. 11 is a diagram illustrating a configuration example of a delay time automatic measurement function;

FIG. 12 is a time chart illustrating an example of delay time automatic measurement processing at the time of preprocessing;

FIG. 13 is a diagram illustrating an internal configuration example of an image quality control unit included in a server of a third embodiment;

FIG. 14 is a diagram for describing a measurement time to be a prediction target of an RSSI value;

FIG. 15 is an example of a time chart for describing a setting example of a target time at which the RSSI value is predicted;

FIG. 16 is a diagram illustrating an internal configuration example of an RSSI prediction unit;

FIG. 17 is a diagram illustrating an internal configuration example of an RSSI prediction processing unit;

FIG. 18 is a diagram illustrating an internal configuration example of an adaptive control unit of a prediction table generation unit; and

FIG. 19 is a diagram illustrating a configuration example for reducing a data size of a prediction table.

### DESCRIPTION OF EMBODIMENTS

Additionally, as an example of a solution using such high-speed wireless communication, a video solution using a high-definition camera image in real time has been considered. For example, a solution for remotely monitoring a work situation by wirelessly transmitting an image obtained by capturing a work site in a factory, a solution for remotely operating a heavy machine while visually recognizing an image by a camera mounted in the heavy machine at a remote place, and the like have been considered.

Furthermore, regarding image transmission control, for example, the following video distribution system has been proposed. In this video distribution system, a video control device estimates an available bandwidth after a predetermined time of a network, determines a needed target buffer data amount based on the estimated available bandwidth, determines an encoding parameter of video data by using the determined target buffer data amount and a data amount accumulated in a reproduction buffer, and transmits the determined encoding parameter to a server device.

Furthermore, the following image encoding transmission rate control method has also been proposed. In this control method, an encoding device provides a frame encoding information amount as an input of an adaptive filter, updates a tap coefficient of the adaptive filter for each frame period so as to minimize an input/output error of the adaptive filter, and determines an encoding parameter according to the output of the adaptive filter.

Meanwhile, since a high radio frequency is used in a high-speed wireless transmission system such as the Wi-Fi 6 or the 5G described above, wireless communication quality is easily affected by an obstacle. Thus, in a case where an image is transmitted using such a wireless transmission system, transmission quality of the image easily changes due to a change in a wireless environment. For example, when the wireless environment deteriorates and a transmittable bandwidth (available bandwidth) decreases, image data may be lost and the image may not be correctly reproduced on a reception side.

Thus, a method of estimating an available bandwidth and controlling an image transmission rate on a transmission side according to the estimated available bandwidth may be considered. However, this method has a problem in how to estimate the available bandwidth.

For example, a method of estimating the available bandwidth based on a data amount of received image data may be considered. However, since the data amount of the image data is changed for each frame, it is needed to use image data received within a fixed period of time in order to accurately estimate the available bandwidth. Thus, a delay occurs from when the available bandwidth actually changes until the change is detected by an estimated value of the available bandwidth. As a result, there is a problem that a real-time property of transmission rate control is low.

In one aspect, an object of an embodiment is to provide an image transmission control device, a method, and a program that improve a real-time property of image transmission rate control.

Hereinafter, embodiments will be described with reference to the drawings.

### First Embodiment

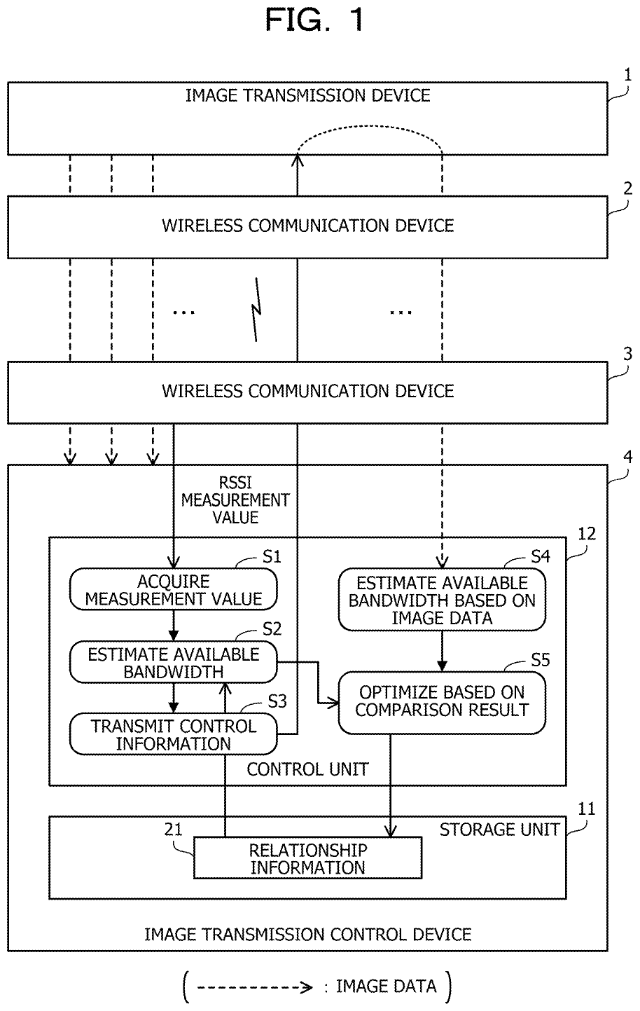

FIG. 1 is a diagram illustrating a configuration example and a processing example of an image transmission system according to a first embodiment. The image transmission system illustrated in FIG. 1 includes an image transmission device 1, wireless communication devices 2 and 3, and an image transmission control device 4.

The image transmission device 1 transmits image data to the image transmission control device 4. For example, the image transmission device 1 transmits image data of each frame of a moving image captured by a camera (not illustrated) to the image transmission control device 4.

The wireless communication devices 2 and 3 are installed in a communication path between the image transmission device 1 and the image transmission control device 4. Wireless communication is performed between the wireless communication device 2 and the wireless communication device 3. Therefore, when image data is transmitted from the image transmission device 1 to the image transmission control device 4, the image data is transmitted from the wireless communication device 2 to the wireless communication device 3 by wireless communication.

The image transmission control device 4 executes predetermined processing by an application or the like using image data received from the image transmission device 1. Furthermore, the image transmission control device 4 controls a transmission rate (transmission speed) of the image data in the image transmission device 1 according to a change in a wireless environment in a wireless transmission path from the wireless communication device 2 to the wireless communication device 3.

This image transmission control device 4 includes a storage unit 11 and a control unit 12. Note that the storage unit 11 is, for example, a storage area of a storage device (not illustrated) included in the image transmission control device 4. Furthermore, the control unit 12 is, for example, a processor included in the image transmission control device 4.

In the storage unit 11, relationship information 21 is stored. The relationship information 21 is information indicating a correspondence relationship between a value of a received signal strength indicator (RSSI) when the wireless communication device 3 receives a signal from the wireless transmission path and an available bandwidth of the wireless transmission path. For example, the relationship information 21 is a conversion table for converting an input RSSI value into a value of an available bandwidth.

The control unit 12 acquires, from the wireless communication device 3, a measurement value of the RSSI (RSSI measurement value) during communication with the image transmission device 1 (step S1). The control unit 12 estimates an available bandwidth in the wireless transmission path from the wireless communication device 2 to the wireless communication device 3 based on the acquired RSSI measurement value and the relationship information 21 in the storage unit 11 (step S2). The control unit 12 generates control information for controlling a transmission rate of image data in the image transmission device 1 based on an estimated value of the available bandwidth, and transmits the generated control information to the image transmission device 1 (step S3). As a result, the transmission rate of the image data is controlled so as not to exceed the estimated available bandwidth.

The image transmission device 1 applies the control information from the image transmission control device 4 to image data transmission processing, and transmits image data reflecting the control information. For example, the control information is information for adjusting a setting value of image quality in encoding processing in the image transmission device 1. In this case, the image transmission device 1 adjusts the setting value of the image quality based on the control information, and encodes the image data after the adjustment. As a result, the image data reflecting the control information is generated. Furthermore, a data amount of the encoded image data changes due to the setting change of the image quality, and as a result, the transmission rate of the image data changes.

The image data reflecting the control information is transmitted to the image transmission control device 4 via the wireless communication devices 2 and 3. In the image transmission control device 4, the control unit 12 estimates an available bandwidth in the wireless transmission path from the wireless communication device 2 to the wireless communication device 3 based on the received image data (step S4).

The control unit 12 compares the available bandwidth estimated in step S4 with the available bandwidth estimated in step S2, and optimizes a correspondence relationship between the RSSI value and the available bandwidth in the relationship information 21 based on the comparison result (step S5). For example, in a case where the estimated value in step S2 is equal to or smaller than the estimated value in step S4, the control unit 12 increases the available bandwidth associated with the RSSI measurement value acquired in step S1 in the relationship information 21. Furthermore, in a case where the estimated value in step S2 is greater than the estimated value in step S4, the control unit 12 decreases the available bandwidth associated with the RSSI value acquired in step S1 in the relationship information 21.

In the above processing, the control unit 12 transmits the control information for the transmission rate control to the image transmission device 1 based on the available bandwidth estimated from the RSSI measurement value using the relationship information 21. As a result, the available bandwidth may be estimated in a short time and the control information based on the estimation result may be transmitted in a short time as compared with a case where the available bandwidth is estimated based on the data amount of the received image data. Thus, a real-time property of the image transmission rate control may be improved.

Furthermore, the correspondence relationship between the RSSI value and the available bandwidth in the relationship information 21 is optimized by the available bandwidth estimated based on the data amount of the received image data. As a result, estimation accuracy of estimating the available bandwidth from the RSSI measurement value using the relationship information 21 may be improved, and as a result, accuracy of the image transmission rate control may be improved. The improvement in the accuracy of the image transmission rate control herein indicates that use efficiency of a bandwidth in the wireless transmission path is improved and an image may be accurately reproduced based on the received image data. For example, as the processing described above is repeatedly executed and the optimization of the relationship information 21 proceeds, the estimation accuracy of the available bandwidth using the relationship information 21 is improved, and as a result, the accuracy of the image transmission rate control is also improved.

Therefore, according to the image transmission control device 4, the image transmission rate control with high real-time property (followability) with respect to a change in the wireless environment and with high accuracy may be executed.

Furthermore, the RSSI value is information that may be usually acquired from most wireless communication devices regardless of a model or a manufacturer. Thus, by using the RSSI value and the received image data, versatility may be improved.

Moreover, since it is not needed to separately prepare hardware for measuring the available bandwidth such as a sensor, a device cost may be reduced.

### Second Embodiment

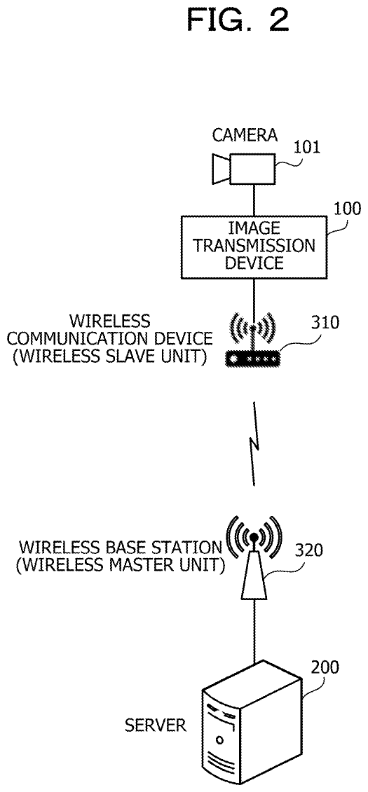

FIG. 2 is a diagram illustrating a configuration example of an image transmission system according to a second embodiment. The image transmission system illustrated in FIG. 2 includes an image transmission device 100 and a server 200.

A camera 101 is coupled to the image transmission device 100. The image transmission device 100 encodes (compresses and encodes) image data of a moving image captured by the camera 101, and transmits the encoded image data to the server 200. The image transmission device 100 is, for example, a terminal device such as a personal computer. In this case, the camera 101 may be built in the image transmission device 100. Furthermore, the image transmission device 100 may be, for example, an edge computer in an edge computing system.

The server 200 is a server computer that receives and decodes (decompresses and decodes) image data transmitted from the image transmission device 100. The server 200 includes, for example, an application that performs processing using the decoded image data. For example, the server 200 includes a production line monitoring application, acquires a moving image obtained by capturing a production line, and detects an event such as occurrence of abnormality from the image. Alternatively, the server 200 includes a remote operation application for various work vehicles, acquires and displays a moving image obtained by capturing a work site, and transmits control information for remotely operating a work vehicle to the image transmission device 100 according to an input operation of an operator who visually recognizes the displayed image. In a case where such a remote operation application is used, the camera 101 and the image transmission device 100 may be mounted in the work vehicle and movable.

Furthermore, a wireless communication device 310 and a wireless base station 320 exist in a communication path between the image transmission device 100 and the server 200. Additionally, wireless communication is performed between the wireless communication device 310 and the wireless base station 320. In the present embodiment, high-speed wireless communication standards such as Long Term Evolution (LTE)-Advanced, 5th generation (5G), and Wi-Fi 6 are used as the wireless communication. For example, the wireless communication device 310 and the wireless base station 320 may be devices included in a local 5G network.

Note that the image transmission device 100 is an example of the image transmission device 1 in FIG. 1, and the server 200 is an example of the image transmission control device 4 in FIG. 1. Furthermore, the wireless communication device 310 is an example of the wireless communication device 2 in FIG. 1, and the wireless base station 320 is an example of the wireless communication device 3 in FIG. 1.

Furthermore, in the present embodiment, as an example, the wireless base station 320 operates as a wireless master unit, and the wireless communication device 310 operates as a wireless slave unit. Furthermore, the wireless communication device 310 may be built in the image transmission device 100.

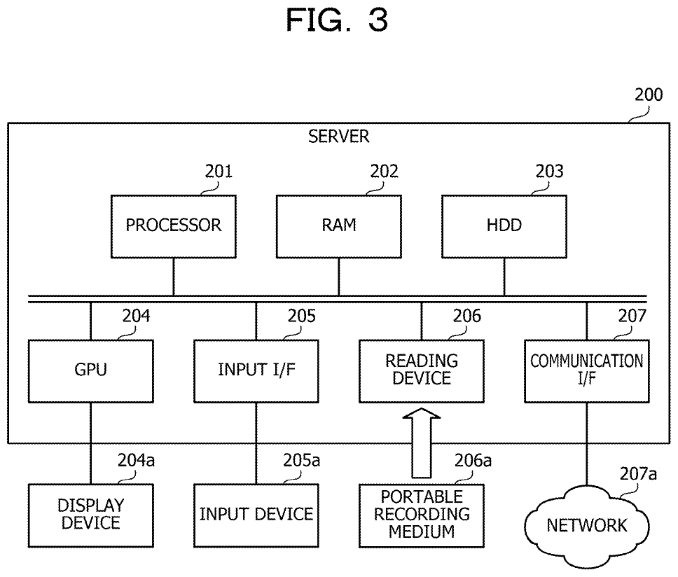

FIG. 3 is a diagram illustrating a hardware configuration example of the server. The server 200 is implemented as, for example, a computer as illustrated in FIG. 3. The server 200 illustrated in FIG. 3 includes a processor 201, a random access memory (RAM) 202, a hard disk drive (HDD) 203, a graphics processing unit (GPU) 204, an input interface (I/F) 205, a reading device 206, and a communication interface (I/F) 207.

The processor 201 integrally controls the entire server 200. The processor 201 is, for example, a central processing unit (CPU), a micro processing unit (MPU), a digital signal processor (DSP), an application specific integrated circuit (ASIC), or a programmable logic device (PLD). Furthermore, the processor 201 may be a combination of two or more elements of the CPU, the MPU, the DSP, the ASIC, and the PLD.

The RAM 202 is used as a main storage device of the server 200. In the RAM 202, at least a part of operating system (OS) programs and application programs to be executed by the processor 201 is temporarily stored. Furthermore, in the RAM 202, various types of data needed for processing by the processor 201 are stored.

The HDD 203 is used as an auxiliary storage device of the server 200. In the HDD 203, the OS programs, the application programs, and various types of data are stored. Note that another type of nonvolatile storage device, such as a solid state drive (SSD), may also be used as the auxiliary storage device.

A display device 204a is coupled to the GPU 204. The GPU 204 displays an image on the display device 204a in accordance with an instruction from the processor 201. As the display device 204a, for example, a liquid crystal display, an organic electroluminescence (EL) display, or the like is used.

An input device 205a is coupled to the input interface 205. The input interface 205 transmits signals output from the input device 205a to the processor 201. As the input device 205a, for example, a keyboard, a pointing device, or the like is used. As the pointing device, for example, a mouse, a touch panel, a tablet, a touch pad, a track ball, or the like is used.

A portable recording medium 206a is attached to and detached from the reading device 206. The reading device 206 reads data recorded in the portable recording medium 206a, and transmits the read data to the processor 201. As the portable recording medium 206a, for example, an optical disk, a semiconductor memory, or the like is used.

The communication interface 207 exchanges data with another device (for example, the wireless base station 320) via a network 207a.

Processing functions of the server 200 may be implemented by the hardware configuration as described above. Note that the image transmission device 100 may also be implemented as a computer having a configuration similar to that of FIG. 3.

Meanwhile, as described above, high-speed wireless communication is performed between the wireless communication device 310 and the wireless base station 320. Since a high radio frequency is used in such wireless communication, communication quality at the time of the wireless communication is easily affected by an obstacle. For example, the higher the radio frequency, the stronger straightness of a radio wave becomes, and radio wave intensity is easily attenuated in a case where a space between antennas is shielded by a person or an object. When the radio wave intensity decreases in this manner, an available bandwidth of data decreases.

In the present embodiment, image data is transmitted from the wireless communication device 310 to the wireless base station 320 by wireless communication, and is finally received by the server 200. In a case where transmission quality (communication speed or the like) of data decreases due to deterioration of a wireless environment as described above, the image data may be lost in a wireless section and the server 200 may not correctly decode the image. Furthermore, there is also a possibility that retransmission of the image data is frequently executed due to the occurrence of the data loss, and in this case, a real-time property of image acquisition is also lost.

Thus, in the present embodiment, the server 200 estimates an available bandwidth (communication speed) in a transmission path, and controls image quality of a transmission image of the image transmission device 100 according to an estimated value of the available bandwidth. The server 200 may control a transmission rate (transmission speed) of an image by changing the image quality.

As a method of changing the image quality, for example, a method of changing a frame rate (frames per second (FPS)) or a method of changing a quantization parameter (QP) value is used. In actual control, only one of these may be used, or both may be used in combination. Note that, as another method of changing the image quality, there is also a method of changing a resolution.

On the other hand, as a method of estimating an available bandwidth, for example, the following first to third estimation methods may be considered.

As the first estimation method, a method of estimating the available bandwidth based on image data received by the server 200 may be considered. For example, there is a method of using, as an available bandwidth, an average reception data amount per unit time based on a data amount of image data received within a fixed period of time. According to this estimation method, the available bandwidth may be estimated relatively accurately. However, since the image data is changed for each frame, it is needed to use image data received in a certain period in order to accurately estimate the available bandwidth. Thus, a delay of about several seconds to several tens of seconds occurs from when the available bandwidth actually changes until the change is detected by an estimated value of the available bandwidth. There is a problem that, due to such a delay, it is difficult to control the image quality in real time according to the actual fluctuation of the available bandwidth.

As the second estimation method, a method of acquiring a wireless transmission rate from a reception device of wireless communication and using the acquired wireless transmission rate as the available bandwidth may be considered. According to this estimation method, the available bandwidth may be estimated quickly and accurately. However, it may be difficult to acquire information needed depending on the reception device, and there is a problem that specifications of the reception device to be used is limited and versatility is low.

As the third estimation method, a method of detecting an obstacle that shields a radio wave using various sensors such as a radar device and a camera, and estimating the available bandwidth from the detection result may be considered. However, there is a problem that it is needed to separately prepare the sensors as hardware, which increases a device cost. Furthermore, it is needed to increase the number of sensors depending on a wireless transmission environment, and in that case, the device cost further increases.

In view of such problems of the respective estimation method, the server 200 of the present embodiment controls the image transmission rate by the following method. First, the estimation of the available bandwidth is basically executed based on wireless information that may be easily acquired from the reception device of the wireless communication (for example, the wireless base station 320). In the present embodiment, as such wireless information, an RSSI value is acquired from the wireless base station 320. The RSSI value is information that may be usually acquired from the reception device of the wireless communication regardless of a model or a manufacturer. Thus, by estimating the available bandwidth based on the RSSI value, the versatility may be improved. Furthermore, by estimating the available bandwidth based on the RSSI value, for example, the available bandwidth may be estimated in a short time as compared with the case of using received image data, and a real-time property of the image transmission rate control may be improved.

Note that estimation accuracy of the available bandwidth based on the RSSI value is lower than that in the case of performing estimation based on the received image data. For example, the RSSI value merely represents strength of the entire received wireless signals, does not represent strength of an image signal itself, and is affected by radio wave interference, a signal other than the image signal included in the received signals, or the like. Furthermore, the RSSI value may fluctuate due to an individual difference or a secular change of the reception device.

Thus, the server 200 of the present embodiment also executes available bandwidth estimation processing based on the received image data, and optimizes the available bandwidth estimation processing based on an RSSI value by using the estimation result. As a result, while improving the real-time property of the image transmission rate control, accuracy of the control is improved.

Moreover, by using the RSSI value and the image data as described above, it is not needed to separately prepare a dedicated sensor for estimating the available bandwidth. Thus, the device cost may be reduced.

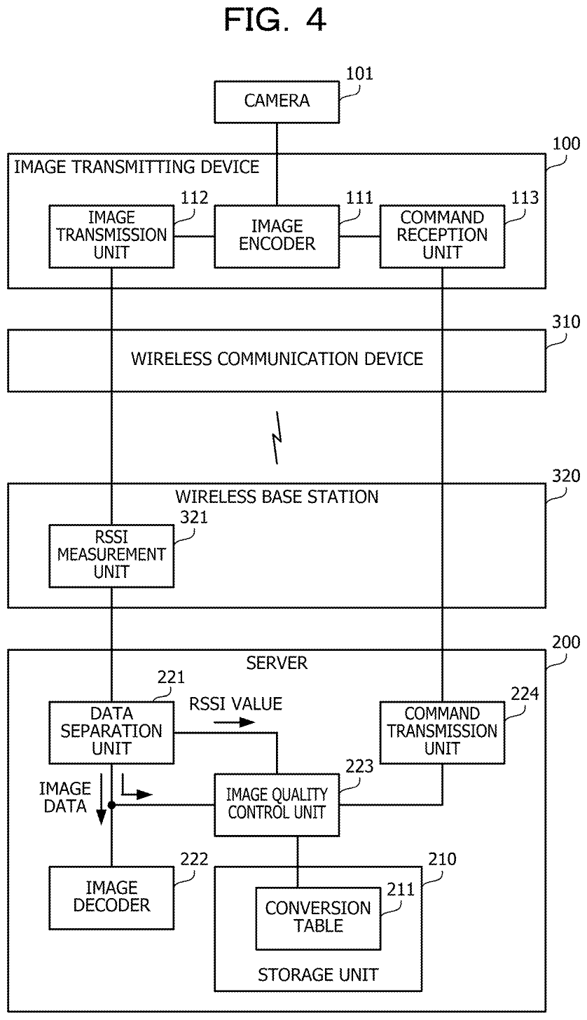

FIG. 4 is a diagram illustrating a configuration example of processing functions provided in each device of the image transmission system.

First, the image transmission device 100 includes an image encoder 111, an image transmission unit 112, and a command reception unit 113. Processing by the image encoder 111, the image transmission unit 112, and the command reception unit 113 is implemented by, for example, a processor (not illustrated) included in the image transmission device 100 executing a predetermined program. Furthermore, at least a part of the processing by these may be executed by dedicated hardware.

The image encoder 111 receives data of an image captured by the camera 101, encodes (compresses and encodes) the received data, and outputs the encoded image data to the image transmission unit 112.

The image transmission unit 112 transmits encoded image data to the server 200. As a result, the image data is transmitted to the server 200 via the wireless communication device 310 and the wireless base station 320.

The command reception unit 113 receives a control command for controlling image quality from the server 200, and controls encoding processing by the image encoder 111 according to the control command. For example, based on the control command, the command reception unit 113 sets at least one of a frame rate and a QP value as a control parameter of the image quality at the time of the encoding processing. By changing these control parameters at the time of the encoding processing, a data amount (image transmission rate) of image data encoded by the image encoder 111 and transmitted via the image transmission unit 112 changes.

Next, the wireless base station 320 includes an RSSI measurement unit 321. The RSSI measurement unit 321 measures an RSSI value at the time of receiving image data from the image transmission device 100, and transmits the measurement result to the server 200. In the present embodiment, the RSSI measurement unit 321 measures the RSSI value at regular time intervals. Furthermore, the RSSI measurement unit 321 adds the measured RSSI value to the image data received from the image transmission device 100, and transmits the image data to the server 200. Note that, as another example, the RSSI measurement unit 321 may measure the RSSI value according to a measurement request at regular time intervals from the server 200, and may return the measured RSSI value to the server 200.

Next, the server 200 includes a storage unit 210, a data separation unit 221, an image decoder 222, an image quality control unit 223, and a command transmission unit 224.

The storage unit 210 is a storage area of a storage device such as the RAM 202 or the HDD 203. In the storage unit 210, a conversion table 211 is stored. The conversion table 211 is table information for converting an RSSI value into an available bandwidth.

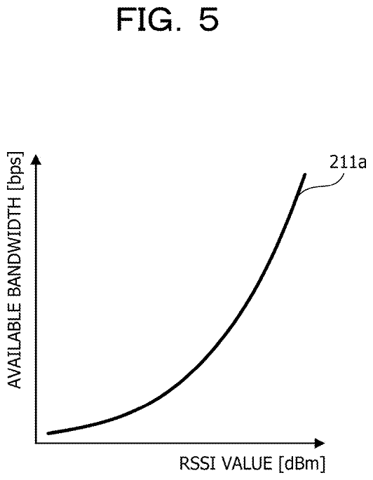

Here, FIG. 5 is a diagram for describing the conversion table. In a graph illustrated in FIG. 5, a curve 211a for converting an RSSI value into an available bandwidth is drawn. The conversion table 211 is implemented as, for example, a lookup table in which an RSSI value is an input (address), an available bandwidth is an output, and a relationship between the input and the output is as indicated by the curve 211a.

Note that information for converting an RSSI value into an available bandwidth is not limited to the conversion table 211. For example, as such information, a coefficient of a polynomial indicating an approximate curve as the curve 211a may be stored in the storage unit 210.

Hereinafter, the description will be continued with reference to FIG. 4.

Processing by the data separation unit 221, the image decoder 222, the image quality control unit 223, and the command transmission unit 224 is implemented by, for example, the processor 201 executing a predetermined program. Furthermore, at least a part of the processing by these may be executed by dedicated hardware.

The data separation unit 221 outputs image data received from the image transmission device 100 to the image decoder 222 and the image quality control unit 223. Furthermore, in a case where an RSSI value is added to the received image data, the data separation unit 221 separates the RSSI value from the received data and outputs the RSSI value to the image quality control unit 223.

The image decoder 222 decodes (decompresses and decodes) image data from the data separation unit 221, and outputs the decoded image data. The output image data is used by an application loaded in the server 200. Furthermore, an image based on the image data may be displayed on the display device 204a.

The image quality control unit 223 refers to the conversion table 211 and converts an RSSI value from the data separation unit 221 into an available bandwidth. Hereinafter, processing of converting an RSSI value into an available bandwidth using the conversion table 211 will be referred to as “estimation of an available bandwidth”. The image quality control unit 223 generates a control parameter for controlling image quality based on the available bandwidth estimated from the RSSI value. As the control parameter, the control parameter is generated such that a transmission rate of an image transmitted from the image transmission device 100 falls within the estimated available bandwidth. The image quality control unit 223 outputs a control command for requesting setting of the generated control parameter to the command transmission unit 224.

Furthermore, the image quality control unit 223 measures an available bandwidth based on image data from the data separation unit 221. In the following description, this processing using the image data will be referred to as “measurement of an available bandwidth”, so that it is referred to be distinguished from the “estimation of an available bandwidth” based on an RSSI value. The image quality control unit 223 compares the measured available bandwidth with an available bandwidth estimated based on an RSSI value. As will be described in detail later, the image quality control unit 223 holds the available bandwidth estimated based on the RSSI value by a delayer for a predetermined time, and compares a measurement value of an available bandwidth based on image data received after a predetermined time from measurement of the RSSI value with the held estimated value of the available bandwidth. The image quality control unit 223 optimizes a correspondence relationship between the RSSI value and the available bandwidth in the conversion table 211 based on such a comparison result.

The command transmission unit 224 transmits a control command output from the image quality control unit 223 to the image transmission device 100.

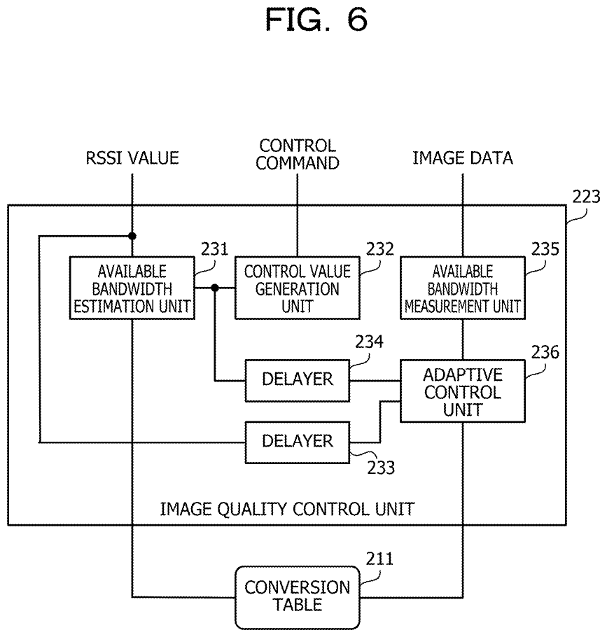

FIG. 6 is a diagram illustrating an internal configuration example of the image quality control unit. The image quality control unit 223 includes an available bandwidth estimation unit 231, a control value generation unit 232, delayers 233 and 234, an available bandwidth measurement unit 235, and an adaptive control unit 236.

The available bandwidth estimation unit 231 refers to the conversion table 211, and estimates an available bandwidth based on an RSSI value from the data separation unit 221. For example, the available bandwidth estimation unit 231 reads the available bandwidth associated with the RSSI value from the conversion table 211, and outputs the read available bandwidth as an estimated value.

The control value generation unit 232 generates, based on an available bandwidth estimated by the available bandwidth estimation unit 231, a control parameter of image quality such that a transmission rate of transmission image falls within the available bandwidth. The control value generation unit 232 outputs a control command for requesting setting of the generated control parameter to the command transmission unit 224.

The delayer 233 delays an RSSI value output from the data separation unit 221 by a predetermined time, and outputs the delayed RSSI value to the adaptive control unit 236. The delayer 234 delays an available bandwidth estimated by the available bandwidth estimation unit 231 only by a predetermined time, and outputs the delayed available bandwidth to the adaptive control unit 236. The delay time for delaying the output by the delayers 233 and 234 is set to be a time until a control command generated based on the estimated available bandwidth is transmitted from the server 200 to the image transmission device 100, image data reflecting image quality setting based on the control command is output from the image encoder 111, and the server 200 receives the image data.

The available bandwidth measurement unit 235 measures an available bandwidth based on image data (before being decoded) received from the image transmission device 100. For example, the available bandwidth measurement unit 235 calculates an average transmission rate from a total amount of data of image data received within a fixed period of time, and outputs the calculated average transmission rate as the available bandwidth.

The adaptive control unit 236 compares an estimated value of an available bandwidth output from the delayer 234 with a measurement value of an available bandwidth output from the available bandwidth measurement unit 235. Based on a comparison result of these, the adaptive control unit 236 optimizes an available bandwidth associated with an RSSI value output from the delayer 233 in the conversion table 211. In this optimization, the available bandwidth of the conversion table 211 is corrected so that an error between the estimated value and the measurement value of the available bandwidth is reduced.

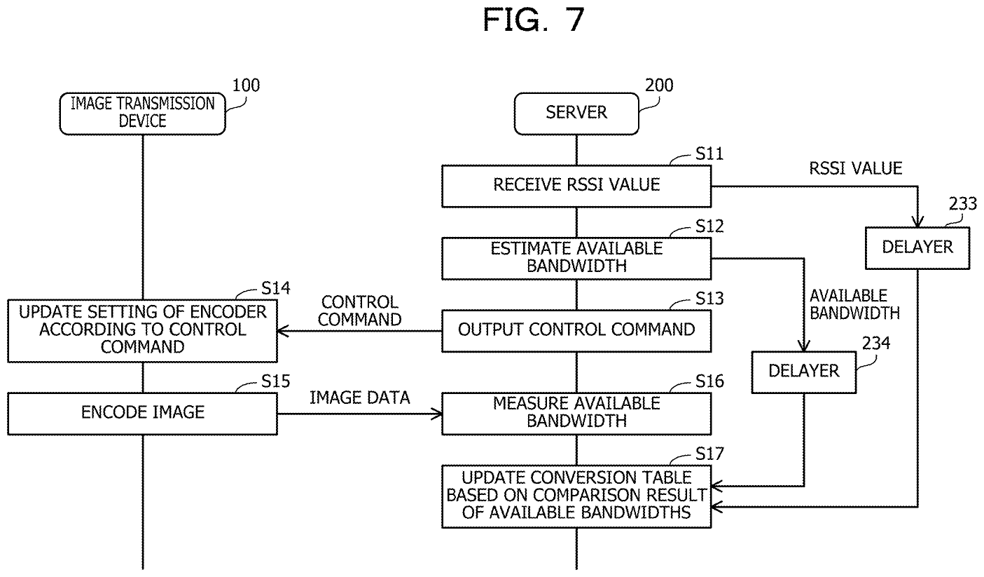

FIG. 7 is an example of a sequence diagram illustrating a flow of image transmission rate control processing.
[Step S11] The server 200 receives image data to which an RSSI value is added. The RSSI value is separated from the image data by the data separation unit 221, and input to the available bandwidth estimation unit 231 of the image quality control unit 223. Note that the separated RSSI value is also input to the delayer 233.
[Step S12] The available bandwidth estimation unit 231 refers to the conversion table 211, and estimates an available bandwidth based on the input RSSI value. The estimated available bandwidth is input to the control value generation unit 232 and the delayer 234.
[Step S13] The control value generation unit 232 generates, based on the available bandwidth estimated by the available bandwidth estimation unit 231, a control parameter of image quality such that a transmission rate of transmission image falls within the available bandwidth. The control value generation unit 232 outputs a control command for requesting setting of the generated control parameter to the command transmission unit 224, and the command transmission unit 224 transmits the control command to the image transmission device 100.
[Step S14] The command reception unit 113 of the image transmission device 100 receives the control command transmitted from the server 200, and updates setting of the control parameter of the image quality in the image encoder 111 according to the control command. As the control parameter, setting of at least one of a frame rate and a QP value is updated.
[Step S15] The image encoder 111 encodes image data from the camera 101 using the updated control parameter. The encoded image data is transmitted to the server 200 by the image transmission unit 112.
[Step S16] In the server 200, the received image data is input from the data separation unit 221 to the image decoder 222 and the image quality control unit 223. The available bandwidth measurement unit 235 of the image quality control unit 223 measures an available bandwidth based on the input image data.
[Step S17] The adaptive control unit 236 compares the estimated value of the available bandwidth output from the delayer 234 with the measurement value of the available bandwidth output from the available bandwidth measurement unit 235. Based on a comparison result of these, the adaptive control unit 236 updates the available bandwidth associated with the RSSI value from the delayer 233 in the conversion table 211.

As described above, the delay time by the delayers 233 and 234 is set to be the time until the control command generated based on the RSSI value is transmitted from the server 200, and the server 200 receives the image data encoded by the encoding processing reflecting the image quality setting based on the control command. Thus, in step S17, the available bandwidth measured in step S16 is compared with the available bandwidth estimated in step S12, and the available bandwidth associated with the RSSI value received in step S11 is updated based on the comparison result.

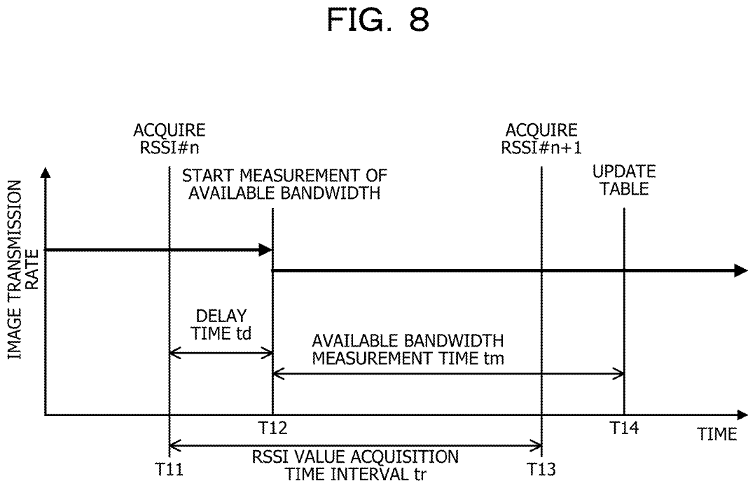

Here, FIG. 8 is an example of a time chart illustrating timings of acquisition of the RSSI value and measurement of the available bandwidth.

The RSSI value is repeatedly acquired at a predetermined acquisition time interval tr. In the example of FIG. 8, an nth RSSI value (RSSI #n) is acquired at a time T11, and an (n+1)th RSSI value (RSSI #n+1) is acquired at a time T13 after the acquisition time interval tr has elapsed from the time T11.

Furthermore, it is assumed that the delay time by the delayers 233 and 234 is td. At a time T12 after the delay time td has elapsed after a control command based on the RSSI #n acquired at the time T11 is transmitted (step S13 in FIG. 7), the measurement of the available bandwidth is started by the available bandwidth measurement unit 235 (step S16). The measurement of the available bandwidth is executed based on image data received during a predetermined measurement time tm. Therefore, in step S16, the available bandwidth is measured based on the image data received after the time T12. Then, in step S17, the measured available bandwidth is compared with an available bandwidth estimated from the RSSI #n acquired at the time T11, and the conversion table 211 is updated based on the comparison result at a time T14.

In this manner, the available bandwidth is measured based on the image data received after the delay time td has elapsed from the acquisition of the RSSI #n. The measurement value is a value measured using image data generated by encoding processing reflecting a control parameter generated based on the RSSI #n. Therefore, by using the comparison result in step S17, a correspondence relationship between the RSSI value and the available bandwidth in the conversion table 211 may be accurately corrected.

By estimating the available bandwidth from the RSSI value by the above processing, the available bandwidth may be estimated in a short time, and the real-time property of the image transmission rate control may be improved. Furthermore, the available bandwidth is measured based on the image data reflecting the control command based on the RSSI value, and the conversion table 211 is optimized based on the measurement value. As a result, the estimation accuracy of the available bandwidth based on the conversion table 211 may be improved.

Therefore, by repeatedly executing the processing described above for a certain period of time, the correspondence relationship between the RSSI value and the available bandwidth in the conversion table 211 is optimized, and the estimation accuracy of the available bandwidth based on the conversion table 211 is improved. For example, at the time of preprocessing before a formal operation of the image transmission system, the processing described above may be repeatedly executed to optimize the conversion table 211, and the formal operation may be started using the optimized conversion table 211. Furthermore, by continuation of the optimization processing of the conversion table 211 even at the time of the formal operation, it is possible to maintain the estimation accuracy of the available bandwidth and maintain the accuracy of the image transmission rate control even in a case where the wireless environment continues to fluctuate.

In this manner, the server 200 may implement the image transmission rate control having high robustness with respect to the wireless communication environment and high real-time property. By such control, use efficiency of a bandwidth in a wireless transmission path may be improved. Moreover, a possibility that image data is lost in the wireless transmission path may be reduced, and an image may be accurately reproduced based on the received image data.

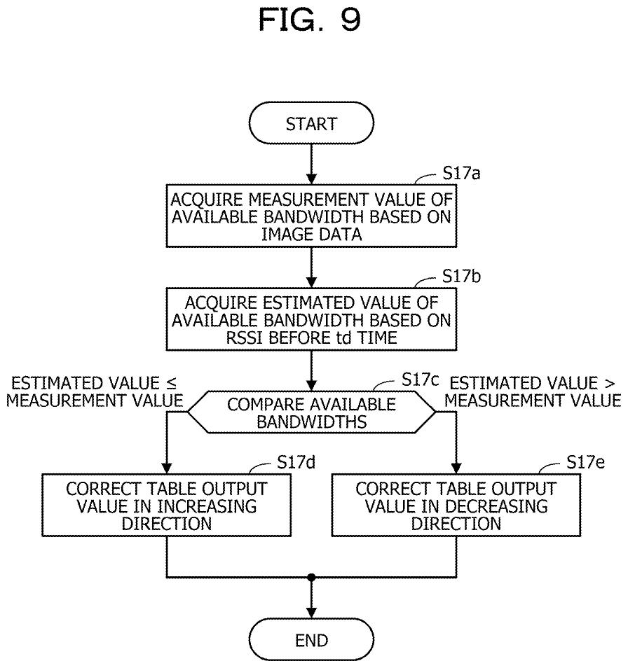

FIG. 9 is an example of a flowchart illustrating a processing procedure of the adaptive control unit. Processing in FIG. 9 corresponds to the processing in step S17 in FIG. 7.
[Step S17a] The adaptive control unit 236 acquires, from the available bandwidth measurement unit 235, the measurement value of the available bandwidth based on the received image data.
[Step S17b] The adaptive control unit 236 acquires, from the delayer 234, the estimated value of the available bandwidth based on the RSSI value measured before the td time.
[Step S17c] The adaptive control unit 236 compares the estimated value of the available bandwidth with the measurement value of the available bandwidth. In a case where the estimated value is equal to or smaller than the measurement value, the processing proceeds to step S17d, and in a case where the estimated value is greater than the measurement value, the processing proceeds to step S17e.
[Step S17d] The adaptive control unit 236 acquires, from the delayer 233, the RSSI value measured before the td time. The adaptive control unit 236 corrects an output value of the available bandwidth associated with the RSSI value in the conversion table 211 in an increasing direction.
[Step S17e] The adaptive control unit 236 acquires, from the delayer 233, the RSSI value measured before the td time. The adaptive control unit 236 corrects an output value of the available bandwidth associated with the RSSI value in the conversion table 211 in a decreasing direction.

According to the processing described above, in a case where the estimated value of the available bandwidth is smaller than the measurement value, it is considered that the estimated value of the available bandwidth for generating the control command is excessively small, and the image quality may be in practice further improved to increase a transmission amount of the image data. Therefore, the adaptive control unit 236 increases the available bandwidth associated with the RSSI value in the conversion table 211. On the other hand, in a case where the estimated value of the available bandwidth is greater than the measurement value, it is considered that the estimated value of the available bandwidth for generating the control command is excessively large, and the transmission amount of the image data is excessively large. Therefore, the adaptive control unit 236 decreases the available bandwidth associated with the RSSI value in the conversion table 211.

Furthermore, in a case where the estimated value of the available bandwidth matches the measurement value, the adaptive control unit 236 does not maintain the available bandwidth associated with the RSSI value in the conversion table 211 but increases the available bandwidth. As a reason for this, it is exemplified that since the method of controlling the image transmission rate based on the estimated available bandwidth is adopted, the actual measurement value is less likely to be greater than the estimated value of the available bandwidth in practice. For such a reason, in a case where the estimated value of the available bandwidth matches the measurement value, it is better to consider that there is room in the actual available bandwidth so that the image transmission rate is brought closer to the actual available bandwidth and the bandwidth may be effectively used.

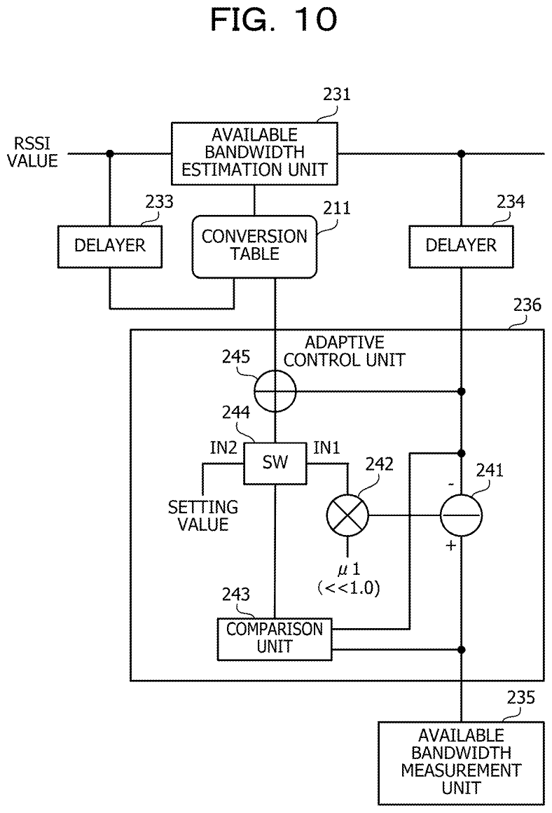

FIG. 10 is a diagram illustrating an internal configuration example of the adaptive control unit. Note that, in FIG. 10, processing functions other than those of the adaptive control unit 236 are also illustrated for easy understanding of the description.

As illustrated in FIG. 10, the adaptive control unit 236 includes, for example, a subtractor 241, a multiplier 242, a comparison unit 243, a switch (SW) 244, and an adder 245.

The subtractor 241 subtracts an available bandwidth estimated by the available bandwidth estimation unit 231 and input via the delayer 234 from an available bandwidth measured by the available bandwidth measurement unit 235, and inputs the subtraction result to the multiplier 242.

The multiplier 242 multiplies an input subtraction result by a preset coefficient μ1. The coefficient μ1 is a value indicating an update rate (increase rate or decrease rate) of an available bandwidth. The coefficient μ1 is set to a value greater than 0 and sufficiently smaller than 1.0 so as not to significantly increase or decrease the available bandwidth. The multiplication result by the multiplier 242 is input to an input terminal IN1 of the switch 244.

The comparison unit 243 compares an available bandwidth estimated by the available bandwidth estimation unit 231 and input via the delayer 234 with an available bandwidth measured by the available bandwidth measurement unit 235. The comparison unit 243 determines whether the estimated value of the available bandwidth is equal to or smaller than the measurement value or whether the estimated value is greater than the measurement value, and inputs the determination result to the switch 244. Note that the determination may be executed based on a sign of a subtraction result by the subtractor 241.

The switch 244 includes the input terminal IN1 and an input terminal IN2. As described above, a multiplication result by the multiplier 242 is input to the input terminal IN1. A setting value fixedly set in advance is input to the input terminal IN2. The switch 244 selectively outputs one of input values from the input terminals IN1 and IN2 to the adder 245 according to an input value from the comparison unit 243. For example, the switch 244 outputs the input value from the input terminal IN2 in a case where the comparison unit 243 determines that an estimated value of an available bandwidth is equal to or smaller than a measurement value, and outputs the input value from the input terminal IN1 in a case where the comparison unit 243 determines that the estimated value is greater than the measurement value. In the latter case, a sign of the input value from the input terminal IN1 is negative.

The adder 245 adds an available bandwidth estimated by the available bandwidth estimation unit 231 and input via the delayer 234 and an output value from the switch 244, and outputs the addition result as an updated available bandwidth to the conversion table 211. In the conversion table 211, an available bandwidth associated with an RSSI value input from the delayer 233 is updated by the output value from the adder 245.

According to the configuration described above, in a case where the estimated value of the available bandwidth is greater than the measurement value, a value corresponding to a difference between the estimated value and the measurement value is subtracted from the estimated value, and the available bandwidth of the conversion table 211 is updated by the value obtained by the subtraction. On the other hand, in a case where the estimated value of the available bandwidth is equal to or smaller than the measurement value, a fixed setting value is added to the estimated value, and the available bandwidth of the conversion table 211 is updated by the value obtained by the addition. In the latter case, the adaptive control unit 236 gradually increases the available bandwidth of the conversion table 211 by a fixed value so as not to rapidly increase the available bandwidth.

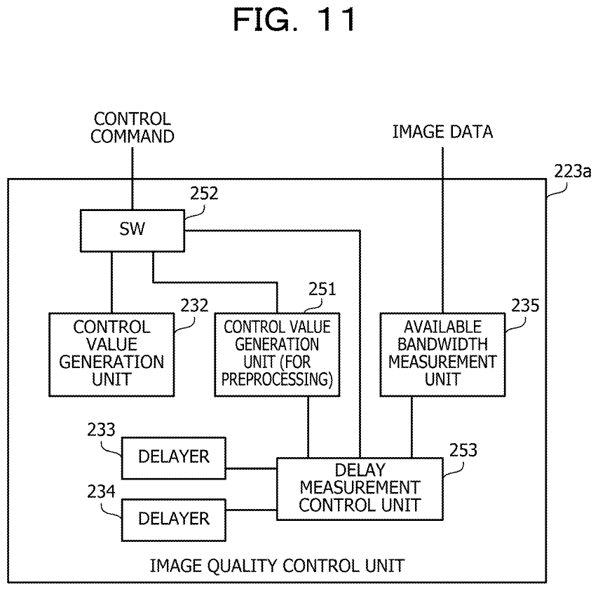

Meanwhile, the server 200 may have a processing function of automatically measuring and setting the delay time td in the delayers 233 and 234. An example of such a processing function will be described with reference to the following FIG. 11.

FIG. 11 is a diagram illustrating a configuration example of a delay time automatic measurement function. An image quality control unit 223a illustrated in FIG. 11 further includes a control value generation unit 251, a switch (SW) 252, and a delay measurement control unit 253 in addition to the processing functions of the image quality control unit 223 illustrated in FIG. 6. Note that, in FIG. 11, among the processing functions of the image quality control unit 223a, processing functions that are not related to the automatic measurement of the delay time td are not illustrated.

In a case where this image quality control unit 223a is used, the automatic measurement processing of the delay time td in the delayers 233 and 234 is executed at the time of the preprocessing before the formal operation of the image transmission system. The control value generation unit 251 is a processing function for the preprocessing, generates a control command for delay measurement under the control of the delay measurement control unit 253, and inputs the generated control command to an input terminal of the switch 252. The control value generation unit 251 alternately outputs a control command for significantly increasing the image transmission rate and a control command for significantly decreasing the image transmission rate.

The control command output from the control value generation unit 232 is input to one input terminal of the switch 252, and the control command output from the control value generation unit 251 is input to the other input terminal. The switch 252 selectively outputs the control command input from any one of the input terminals to the command transmission unit 224 according to a switching control signal from the delay measurement control unit 253. For example, under the control of the delay measurement control unit 253, the control command input from the control value generation unit 251 is output to the command transmission unit 224 at the time of the preprocessing, and the control command input from the control value generation unit 232 is output to the command transmission unit 224 at the time of the formal operation.

The delay measurement control unit 253 measures, at the time of the preprocessing, the delay time td in the delayers 233 and 234 based on a situation of a change in an available bandwidth measured by the available bandwidth measurement unit 235, and sets the delay time td in the delayers 233 and 234.

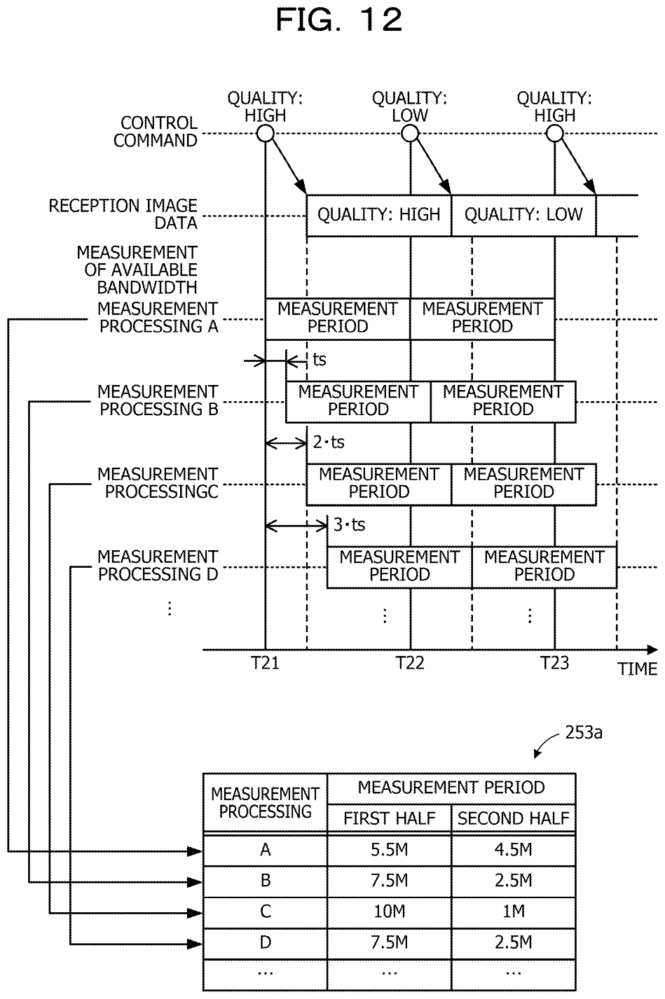

FIG. 12 is a time chart illustrating an example of the delay time automatic measurement processing at the time of the preprocessing.

The control value generation unit 251 alternately outputs the control command for significantly increasing the image transmission rate (significantly increasing an image data size) and the control command for significantly decreasing the image transmission rate (significantly decreasing the image data size). The former control command significantly increases image quality to increase a size of a transmission image data, and the latter control command significantly decreases the image quality to decrease the size of the transmission image data.

In the example of FIG. 12, the measurement processing of the delay time td is started at a time T21, and such control commands are alternately output at regular time intervals. Here, as an example, it is assumed that the output time interval of the control command is the same as a measurement interval of an RSSI value. In the example of FIG. 12, at the time T21, the control command for increasing the image quality is transmitted to the image transmission device 100 via the switch 252. Thereafter, at a time T22 after a fixed period of time has elapsed, the control command for decreasing the image quality is transmitted to the image transmission device 100 via the switch 252. Moreover, thereafter, at a time T23 after a fixed period of time has elapsed, the control command for increasing the image quality is transmitted to the image transmission device 100 via the switch 252.

From the image transmission device 100, at a timing delayed from the transmission of the control command at the time T21, image data of an image with high image quality reflecting the control command is received. Furthermore, at a timing delayed from the transmission of the control command at the time T22, image data of an image with low image quality reflecting the control command is received. In accordance with an instruction from the delay measurement control unit 253, the available bandwidth measurement unit 235 measures an available bandwidth based on the received image data in the following procedure.

The available bandwidth measurement unit 235 executes measurement processing A, B, C, D, . . . of an available bandwidth. It is assumed that a measurement period in each measurement processing is divided into a first half and a second half, and lengths of the first half and the second half measurement periods are the same as the output interval of the control command. Then, in each of the first half and the second half measurement periods, the available bandwidth measurement unit 235 measures an available bandwidth based on image data received in the measurement period.

Here, the measurement processing A is started at the measurement start time (time T21) of the delay time td. Furthermore, the measurement processing B is started at a time shifted after the time T21 by a unit time ts (T21+ts). The measurement processing C is started at a time further shifted after this time by the unit time ts (T21+2·ts). The measurement processing D is started at a time further shifted after this time by the unit time ts (T21+3·ts). In this manner, each of the measurement processing A, B, C, D, . . . is executed while shifting the start time by a fixed period of time.

Note that the measurement processing A, B, C, D, . . . may be executed in parallel as in the example of FIG. 12. For example, in a case where received image data is temporarily held in a buffer of a predetermined size, the server 200 may execute the measurement processing A, B, C, D, . . . in parallel by acquiring image data of a corresponding measurement period from the image data held in the buffer.

A management table 253a illustrated on a lower side of FIG. 12 is an example of information for holding a measurement result of an available bandwidth, and is stored in, for example, the storage unit 210. In the management table 253a, a measurement value of an available bandwidth measured in the first half measurement period and a measurement value of the available bandwidth measured in the second half measurement period are registered in association with each of the measurement processing A, B, C, D, . . . having different shift times of the measurement start time. Note that the measurement processing having the same shift time at the start of measurement may be repeatedly executed a plurality of times. In this case, as the measurement values corresponding to the first half and the second half, it is sufficient that average values of the measurement values of the available bandwidth measured in the plurality of times of the measurement processing are registered.

For example, the delay measurement control unit 253 refers to the management table 253a and specifies measurement processing having the largest difference between the measurement value in the first half and the measurement value in the second half in the measurement processing. In the example of FIG. 12, the measurement processing C in which the measurement start time is shifted by 2·ts is specified as the measurement processing having the largest difference between the measurement values. In this case, the delay measurement control unit 253 determines the delay time td as 2·ts, and sets the delay time td of 2·ts in the delayers 233 and 234.

With such processing, the delay time td may be automatically and accurately measured. Furthermore, for example, in a state where the wireless communication device 310 and the wireless base station 320 are actually installed and the image transmission device 100 is actually caused to execute encoding of image data, the delay time td matching the environment may be automatically measured. Thus, regardless of the installation environment of the wireless communication device 310 and the wireless base station 320, the delay time td may be accurately measured, and as a result, the image transmission rate control may be executed with high accuracy at the time of the formal operation.

### Third Embodiment

Next, an image transmission system according to a third embodiment will be described. In the third embodiment, a part of the processing of the server 200 in the second embodiment is modified.

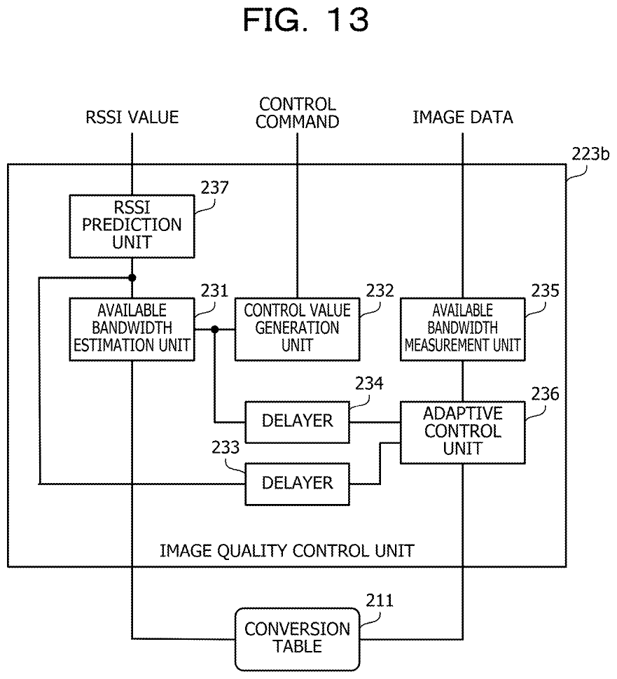

FIG. 13 is a diagram illustrating an internal configuration example of an image quality control unit included in a server of the third embodiment. A server 200 of the third embodiment includes an image quality control unit 223b illustrated in FIG. 13 instead of the image quality control unit 223 illustrated in FIG. 6. The image quality control unit 223b has a configuration in which an RSSI prediction unit 237 is further added to the image quality control unit 223 illustrated in FIG. 6.

In the second embodiment, after the server 200 transmits the control command based on the RSSI value, a time difference occurs until the server 200 receives the image data reflecting the control command and optimizes the conversion table 211 based on the image data. Thus, it takes time to improve the estimation accuracy of the available bandwidth based on the conversion table 211.

Thus, in the third embodiment, the RSSI prediction unit 237 predicts an RSSI value after a fixed period of time based on an input RSSI value, and inputs the predicted RSSI value to an available bandwidth estimation unit 231 and a delayer 233. As a result, an available bandwidth is estimated based on the predicted value of the RSSI value after the fixed period of time, and a control command based on the estimated value is transmitted to an image transmission device 100. As a result, a time at which an actual measurement value of the RSSI value changes to the predicted value approaches a time at which the server 200 receives image data reflecting the transmitted control command and optimizes a conversion table 211 based on the image data.

As a result, it is possible to cause the estimated value of the available bandwidth based on the conversion table 211 to follow the change in the RSSI value, for example, an actual change in the available bandwidth at high speed. Therefore, it is possible to improve a control response of an image transmission rate based on the estimated value of the available bandwidth and to improve accuracy of the control.

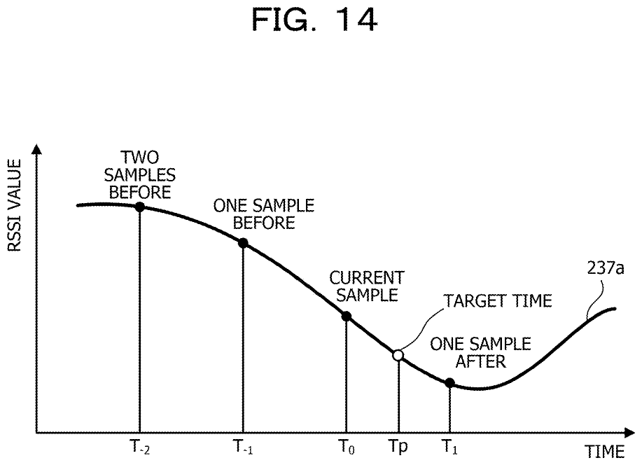

FIG. 14 is a diagram for describing a measurement time to be a prediction target of the RSSI value.

As described above, the RSSI value is acquired at a fixed acquisition time interval tr. In FIG. 14, an example of the RSSI value measured at each acquisition time is indicated in a graph, and a transition of the RSSI value measured at each acquisition time is indicated by an approximate curve 237a. Furthermore, in FIG. 14, it is assumed that a time T₀ is a time at which a latest RSSI value is acquired (current time), a time T₋₁ is a time at which an RSSI value one sample before is acquired, a time T₋₂ is a time at which an RSSI value two samples before is acquired, and a time T₁ is a time at which an RSSI value one sample after is acquired. For example, each of a time from the time T₋₂ to the time T₋₁, a time from the time T₋₁ to the time T₀, and a time from the time T₀ to the time T₁ is the acquisition time interval tr.

A future measurement time (target time Tp) at which an RSSI value is predicted by the RSSI prediction unit 237 is a time after a fixed period of time from the time T₀. The RSSI prediction unit 237 predicts an RSSI value at the target time Tp based on the RSSI value acquired at each of the plurality of acquisition times including the current time. As will be described in detail later, in the present embodiment, as an example, the RSSI prediction unit 237 predicts the RSSI value at the target time Tp by interpolation based on the RSSI value at each of the time T₋₁, the time T₀, and the time T₁. Furthermore, the RSSI prediction unit 237 predicts the RSSI value at the time T₁ as a future time among the times described above using a prediction table that holds correspondence relationships between the plurality of samples of the RSSI value and the predicted value of the RSSI value at the future time.

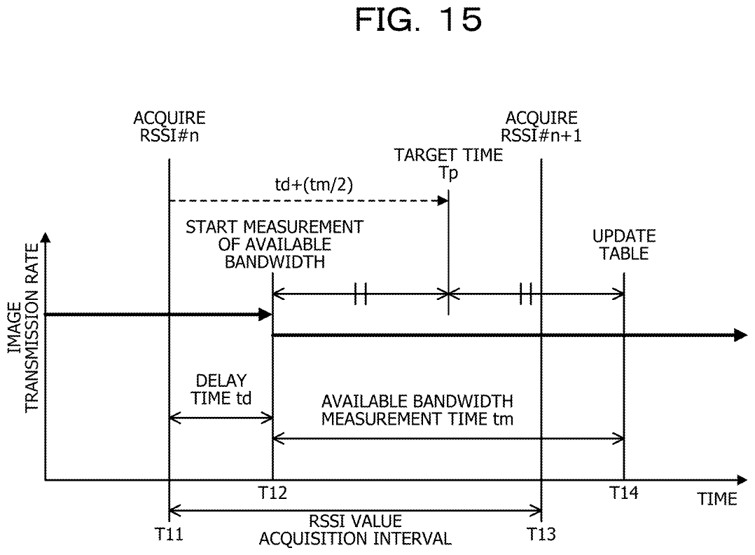

FIG. 15 is an example of a time chart for describing a setting example of the target time at which the RSSI value is predicted. In FIG. 15, the same times as in FIG. 8 are denoted by the same reference signs. Furthermore, in FIG. 15, times T11 and T13 correspond to the times T₀ and T₁ in FIG. 14, respectively.

As described above, a delay time td is set to be a time until a control command generated based on a measured RSSI value is transmitted from the server 200, and the server 200 receives image data reflecting the control command. Thus, the target time Tp is set to a time after a time equal to or longer than the delay time td has elapsed from the current time T11.

Furthermore, in the present embodiment, an available bandwidth measurement unit 235 measures an available bandwidth based on image data received during a fixed measurement time tm. For example, the available bandwidth measurement unit 235 calculates, as a measurement value of the available bandwidth, a data amount (average value of image transmission rates) obtained by dividing a total data amount of the image data received during the measurement time tm by the measurement time tm. Thus, as the target time Tp, it is desirable to set an intermediate time in a period from a time T12 at which the measurement of the available bandwidth is started to a time T14 after the measurement time tm has elapsed. For example, the target time Tp is set to a time later than the current time T11 by a time {td+(tm/2)}.

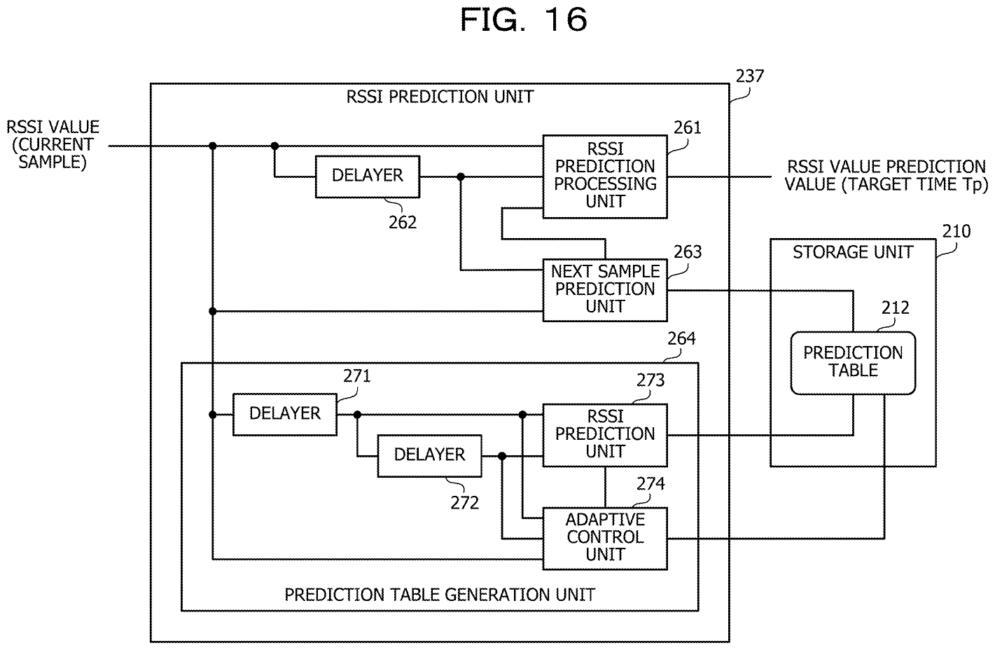

FIG. 16 is a diagram illustrating an internal configuration example of the RSSI prediction unit. As illustrated in FIG. 16, the RSSI prediction unit 237 includes an RSSI prediction processing unit 261, a delayer 262, a next sample prediction unit 263, and a prediction table generation unit 264. Furthermore, a storage unit 210 further stores a prediction table 212.

The RSSI prediction processing unit 261 predicts an RSSI value (RSSI prediction value) at the target time Tp based on an RSSI value measured at a current time (current sample), an RSSI value measured at an immediately previous acquisition time (previous sample), and a predicted value of an RSSI value at a next acquisition time (next sample). This prediction is executed by an interpolation operation. For example, the RSSI prediction processing unit 261 generates an approximate function based on the previous sample, the current sample, and the next sample of the RSSI value, and inputs the target time Tp to the approximate function to calculate the RSSI prediction value at the target time Tp.

The delayer 262 delays the current sample of the RSSI value by the delay time td to generate the previous sample of the RSSI value, and inputs the generated previous sample to the RSSI prediction processing unit 261 and the next sample prediction unit 263.

The next sample prediction unit 263 refers to the prediction table 212, predicts the next sample of the RSSI value based on the current sample of the RSSI value and the previous sample of the RSSI value input from the delayer 262, and inputs the predicted next sample to the RSSI prediction processing unit 261.

The prediction table 212 is table information in which the predicted value of the next sample is associated with a combination of the current sample and the previous sample of the RSSI value.

The prediction table generation unit 264 optimizes the prediction table 212 based on the RSSI values acquired at the plurality of acquisition times.

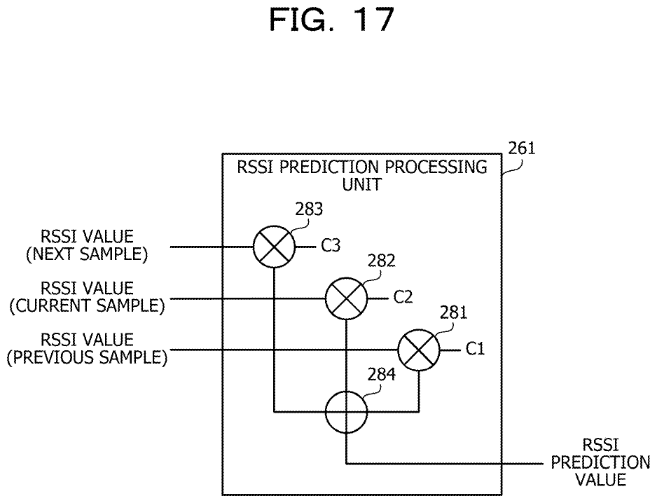

FIG. 17 is a diagram illustrating an internal configuration example of the RSSI prediction processing unit. As illustrated in FIG. 17, the RSSI prediction processing unit 261 includes multipliers 281 to 283 and an adder 284.

The multiplier 281 multiplies the previous sample of the RSSI value input from the delayer 262 by a coefficient C1. The multiplier 282 multiplies the current sample of the RSSI value input from a data separation unit 221 by a coefficient C2. The multiplier 283 multiplies the next sample of the RSSI value predicted by the next sample prediction unit 263 by a coefficient C3. The adder 284 adds the respective multiplication results of the multipliers 281 to 283 and outputs the addition value as the RSSI prediction value at the target time Tp.

Here, the coefficients C1 to C3 are weighting coefficients for calculating the RSSI prediction value at the target time Tp by the interpolation operation, and are obtained in advance based on the target time Tp as coefficients of a sinc function, for example.

Hereinafter, the description will be continued with reference to FIG. 16.

The prediction table generation unit 264 includes delayers 271 and 272, an RSSI prediction unit 273, and an adaptive control unit 274.

The delayer 271 delays an RSSI value input from the data separation unit 221 by the delay time td, and inputs the delayed RSSI value to the RSSI prediction unit 273, the delayer 272, and the adaptive control unit 274. The delayer 272 further delays the RSSI value input from the delayer 271 by the delay time td, and inputs the delayed RSSI value to the RSSI prediction unit 273 and the adaptive control unit 274.

The RSSI prediction unit 273 reads, in the prediction table 212, a predicted value of an RSSI value (third RSSI value) associated with a first RSSI value input from the delayer 271 and a second RSSI value input from the delayer 272 and one sample before the first RSSI value. This third RSSI value is a predicted value of an RSSI value at the current time predicted based on the first RSSI value that is an RSSI value one sample before the current time and the second RSSI value that is an RSSI value two samples before the current time. The RSSI prediction unit 273 inputs the read third RSSI value (predicted value) to the adaptive control unit 274.

The adaptive control unit 274 compares a predicted value of an RSSI value at the current time input from the RSSI prediction unit 273 with the RSSI value (measurement value) at the current time input from the data separation unit 221. Based on the comparison result of these, the adaptive control unit 274 optimizes a corresponding output value among output values registered in the prediction table 212 so as to reduce an error between the predicted value and the measurement value of the RSSI value. As described above, the combination of the current sample and the previous sample of the RSSI value is set as an input value in the prediction table 212. In the optimization of the output value, the output value associated with the combination of the first RSSI value from the delayer 271 as the current sample and the second RSSI value from the delayer 272 as the previous sample is optimized.

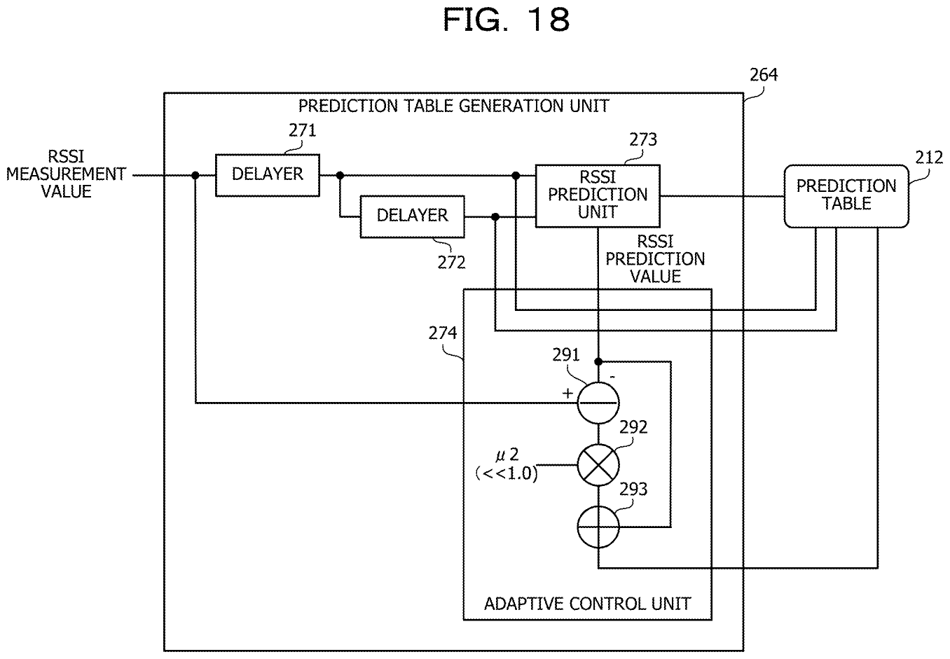

FIG. 18 is a diagram illustrating an internal configuration example of the adaptive control unit of the prediction table generation unit. In FIG. 18, for easy understanding of the description, other components in the prediction table generation unit 264 and the prediction table 212 are also illustrated.

The adaptive control unit 274 includes a subtractor 291, a multiplier 292, and an adder 293.

The subtractor 291 subtracts an RSSI prediction value predicted by the RSSI prediction unit 273 from an RSSI measurement value input from the data separation unit 221.

The multiplier 292 multiplies a subtraction result by the subtractor 291 by a preset coefficient μ2. The coefficient μ2 is a value indicating an update rate (increase rate or decrease rate) of an output value of the prediction table 212. The coefficient μ2 is set to a value greater than 0 and sufficiently smaller than 1.0 so as not to significantly increase or decrease the output value.

The adder 293 adds a multiplication result by the multiplier 292 to an RSSI prediction value predicted by the RSSI prediction unit 273.

In the prediction table 212, the adaptive control unit 274 updates output values associated with RSSI values output from the delayers 271 and 272 as a current sample and a previous sample, respectively, by an addition result by the adder 293. By this processing, in a case where the RSSI prediction value from the RSSI prediction unit 273 is greater than an RSSI measurement value from the data separation unit 221, a corresponding output value in the prediction table 212 is decreased by a value corresponding to magnitude of a difference between the RSSI prediction value and the RSSI measurement value. On the other hand, in a case where the RSSI prediction value from the RSSI prediction unit 273 is smaller than the RSSI measurement value from the data separation unit 221, the corresponding output value in the prediction table 212 is increased by a value corresponding to magnitude of a difference between the RSSI prediction value and the RSSI measurement value.

According to the above configurations illustrated in FIGS. 16 to 18, the next sample of the RSSI value is predicted by the next sample prediction unit 263 based on the prediction table 212, and the prediction table 212 is optimized by the prediction table generation unit 264. As the prediction table 212 is optimized with a lapse of time, prediction accuracy of the next sample prediction unit 263 is improved, and accordingly, prediction accuracy of the RSSI prediction value at the target time Tp by the RSSI prediction processing unit 261 is also improved. As the prediction accuracy in the RSSI prediction processing unit 261 is improved, estimation accuracy of the available bandwidth by the available bandwidth estimation unit 231 is also improved. As a result, it is possible to improve the control response of the image transmission rate based on the estimated value of the available bandwidth and to improve the accuracy of the control.

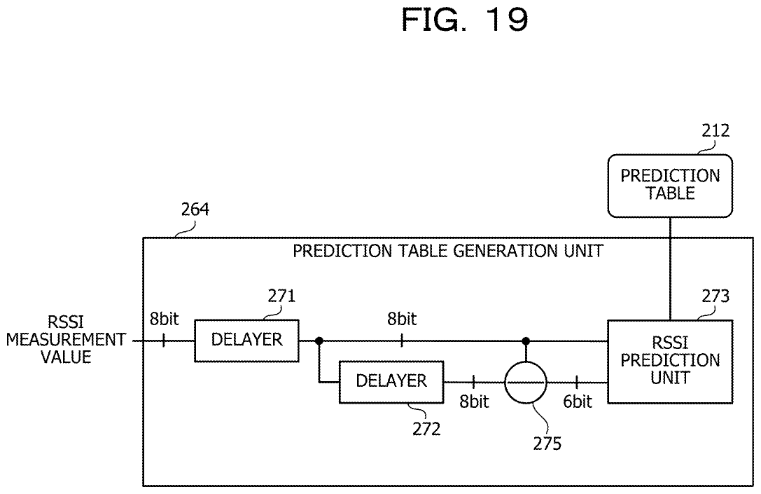

Meanwhile, in the prediction table 212, since an RSSI output value is stored in association with each of a combination of two RSSI input values, a data size is large. Thus, the data size of the prediction table 212 may be reduced by adopting the following configuration as illustrated in FIG. 19 as the configuration of the prediction table generation unit 264.

FIG. 19 is a diagram illustrating a configuration example for reducing the data size of the prediction table. As illustrated in FIG. 19, a subtractor 275 is further added to the prediction table generation unit 264.

In FIG. 19, as an example, it is assumed that an RSSI value is represented by 8 bits. In this case, RSSI values output from the delayers 271 and 272 are also 8-bit data. Furthermore, the 8-bit RSSI value from the delayer 271 is also input as an input value of a current sample in the RSSI prediction unit 273.

On the other hand, the subtractor 275 calculates a difference between the 8-bit RSSI value from the delayer 271 and the 8-bit RSSI value from the delayer 272 to generate an RSSI value in which the number of bits is reduced to, for example, 6 bits. The generated 6-bit RSSI value is input as an input value of a previous sample in the RSSI prediction unit 273.

With such a configuration, the number of bits of an address of the prediction table 212 (the total number of bits of an RSSI input value) may be reduced. As a result, the data size of the prediction table 212 may be reduced. Furthermore, there is a low possibility that a value greatly changes between a certain sample and a previous sample of an RSSI value. Thus, even when the number of bits of one of the RSSI input values is reduced by the subtractor 275 described above, there is a low possibility that the prediction accuracy using the prediction table 212 decreases. For example, with the configuration described above, the data size of the prediction table 212 may be reduced without decreasing the prediction accuracy.

Note that the processing functions of the devices (for example, the image transmission devices 1 and 100, the image transmission control device 4, and the server 200) indicated in each of the embodiments described above may be implemented by a computer. In that case, a program describing processing content of functions to be held by each device is provided, and the processing functions described above are implemented in the computer by execution of the program in the computer. The program describing the processing content may be recorded in a computer-readable recording medium. The computer-readable recording medium includes a magnetic storage device, an optical disk, a semiconductor memory, or the like. The magnetic storage device includes a hard disk drive (HDD), a magnetic tape, or the like. The optical disk includes a compact disc (CD), a digital versatile disc (DVD), a Blu-ray disc (BD, registered trademark), and the like.

In a case where the program is to be distributed, for example, portable recording media such as DVDs or CDs in which the program is recorded are sold. Furthermore, it is also possible to store the program in a storage device of a server computer, and transfer the program from the server computer to another computer via a network.

The computer that executes the program stores, for example, the program recorded in the portable recording medium or the program transferred from the server computer in its own storage device. Then, the computer reads the program from its own storage device, and executes processing according to the program. Note that the computer may also read the program directly from the portable recording medium and execute the processing according to the program. Furthermore, the computer may also sequentially execute processing according to the received program each time the program is transferred from the server computer coupled via the network.

The above description merely indicates a principle of the present invention. Moreover, numerous modifications and variations may be made by those skilled in the art, and the present invention is not limited to the above-described or illustrated exact configuration and application example, and all corresponding modifications and equivalents are regarded to fall within the scope of the present invention by appended claims and equivalents thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image transmission control device comprising:
a memory; and
a processor coupled to the memory and configured to:
store, in the memory, relationship information that indicates a correspondence relationship between a received signal strength indicator at a time of reception of a signal from a wireless transmission path and an available bandwidth of data transmission in the wireless transmission path;
acquire a measurement value of the received signal strength indicator during communication with an image transmission device that transmits image data via a communication path that includes the wireless transmission path;
estimate a first available bandwidth in the wireless transmission path based on the measurement value and the relationship information;
generate control information for adjustment of a transmission rate of image data in the image transmission device based on the first available bandwidth;
transmit the control information to the image transmission device;
measure, when image data that reflects the control information is received from the image transmission device, a second available bandwidth in the wireless transmission path based on the received image data; and
optimize the correspondence relationship in the relationship information based on a comparison result between the first available bandwidth and the second available bandwidth.

2. The image transmission control device according to claim 1, wherein,
in the optimization of the correspondence relationship,
in a case where the first available bandwidth is greater than the second available bandwidth, a value of an available bandwidth associated with the measurement value in the relationship information is decreased, and
in a case where the first available bandwidth is smaller than the second available bandwidth, and in a case where the first available bandwidth is equal to the second available bandwidth, a value of an available bandwidth associated with the measurement value in the relationship information is increased.

3. The image transmission control device according to claim 1, wherein
the first available bandwidth is an available bandwidth associated with the measurement value in the relationship information.

4. The image transmission control device according to claim 1, wherein,
in the estimation of the first available bandwidth,
a first predicted value of the received signal strength indicator after a predetermined time from an acquisition time of the measurement value is calculated based on the measurement value and one or more other measurement values of the received signal strength indicator measured before acquisition of the measurement value, and
an available bandwidth associated with the first predicted value in the relationship information is output as the first available bandwidth.

5. The image transmission control device according to claim 4, wherein
the second available bandwidth is measured based on image data received from the image transmission device after a predetermined delay time has elapsed from the estimation of the first available bandwidth, and
a length of the predetermined time is equal to or longer than the delay time.

6. The image transmission control device according to claim 4, wherein
the received signal strength indicator is measured at each measurement timing at regular time intervals,
the first predicted value is calculated based on the measurement value measured at a most recent first measurement timing, a first another measurement value of the received signal strength indicator measured at a second measurement timing before the first measurement timing, and a second predicted value of the received signal strength indicator measured at a third measurement timing after the first measurement timing, and
the second predicted value is calculated based on another piece of relationship information that indicates a correspondence relationship between a combination of the received signal strength indicator measured at a fourth measurement timing and the received signal strength indicator measured at a fifth measurement timing before the fourth measurement timing, and the received signal strength indicator measured at a sixth measurement timing after the fourth measurement timing.

7. The image transmission control device according to claim 6, wherein
the processor further
optimizes the another piece of relationship information based on the measurement value, the first another measurement value, and a second another measurement value of the received signal strength indicator measured at the third measurement timing before the second measurement timing.

8. An image transmission control method comprising:
storing, in the memory, relationship information that indicates a correspondence relationship between a received signal strength indicator at a time of reception of a signal from a wireless transmission path and an available bandwidth of data transmission in the wireless transmission path;
acquiring a measurement value of the received signal strength indicator during communication with an image transmission device that transmits image data via a communication path that includes the wireless transmission path;
estimating a first available bandwidth in the wireless transmission path based on the measurement value and the relationship information;
generating control information for adjustment of a transmission rate of image data in the image transmission device based on the first available bandwidth;
transmitting the control information to the image transmission device;
measuring, when image data that reflects the control information is received from the image transmission device, a second available bandwidth in the wireless transmission path based on the received image data; and
optimizing the correspondence relationship in the relationship information based on a comparison result between the first available bandwidth and the second available bandwidth.

9. A non-transitory computer readable recording medium storing an image transmission control program causing a computer to execute a process of:
storing, in the memory, relationship information that indicates a correspondence relationship between a received signal strength indicator at a time of reception of a signal from a wireless transmission path and an available bandwidth of data transmission in the wireless transmission path;
acquiring a measurement value of the received signal strength indicator during communication with an image transmission device that transmits image data via a communication path that includes the wireless transmission path;
estimating a first available bandwidth in the wireless transmission path based on the measurement value and the relationship information;
generating control information for adjustment of a transmission rate of image data in the image transmission device based on the first available bandwidth;
transmitting the control information to the image transmission device;
measuring, when image data that reflects the control information is received from the image transmission device, a second available bandwidth in the wireless transmission path based on the received image data; and
optimizing the correspondence relationship in the relationship information based on a comparison result between the first available bandwidth and the second available bandwidth.
